(19) United States
(12) Patent Application Publication
(10) Pub. No.: US 2015/0241976 A1
(43) Pub. Date: Aug. 27, 2015

(54) WEARABLE FINGER RING INPUT DEVICE AND CONTROLLER

(71) Applicant: NVIDIA Corporation, Santa Clara, CA (US)

(72) Inventors: Yu ZHAO, Shenzen (CN); Xiang SUN, Shenzhen (CN); Fei WANG, Guangzhou (CN)

(73) Assignee: NVIDIA Corporation, Santa Clara, CA (US)

(21) Appl. No.: 14/186,252

(22) Filed: Feb. 21, 2014

(51) Int. Cl. G06F 3/01; G06F 3/0338; G06F 3/0488

(52) U.S. Cl. CPC G06F 3/017; G06F 3/014; G06F 3/04886; G06F 3/0488; G06F 3/0338; G06F 2203/0331; G06F 2203/04803; G06F 2203/04808

(57) ABSTRACT

Systems and methods for remotely providing user input to different electronic devices based on user finger motions and/or gestures. A universal user input device assembles a motion sensor, control logic, a memory and a processor into a substantially ring-shaped housing that is wearable on a finger of a user. The input device can identify an associated external device, establish a communication channel therewith, and provide user input instructions to the external device based on user's finger motions or gestures. The motion sensor can detect the finger's motions and/or gestures and generate corresponding detection signals which are converted into instruction signals recognizable by the external device. The instruction signals are communicated to the external device through a wireless communication channel. The input device may include a projector that can optically project a graphic user interface to an external surface as a visual guide for user's finger motions or gestures.

### TECHNICAL FIELD

The present disclosure relates generally to the field of electronic control devices and, more specifically, to the field of wearable electronic devices.

### BACKGROUND

In general, a user input device, e.g., a control panel, or a user input terminal, operates to receive user input and issue recognizable commands to an electronic device, e.g., a television or a computer. A remote input device, such as a remote control or a wireless input terminal, enables a user to control or provide input to an electronic device in a convenient distance. The proliferation of consumer electronic products drives an ever-increasing number of electronic devices owned by the average household. Typically, each electronic device is equipped with its own remote input device that is designed and programmed by its manufacturer specifically for the device model. Many remote input devices have a similar exterior appearance and yet different user interface designs. A user often finds it burdensome and confusing to locate a particular input device and use it in the particular manner.

Some technologies have been developed and allow a user to remotely provide user input to an electronic device without using a handheld input device. For example, a user's voice or eye motions can be interpreted into input instructions recognizable by the associated electronic device. Most users have been accustomed to using fingers to interact with an input device through the regular use of remote controls, cursor directing mechanisms, and keyboards. However, there has been a lack of remote input mechanisms that allow a user to interact with electronic devices through finger motions without requiring the handholding of an input device.

### SUMMARY OF THE INVENTION

Therefore, it would be advantageous to provide a universal input device which allows a user to remotely interact with different electronic devices by using finger motions and gestures. Accordingly, embodiments of the present disclosure include a motion sensor, control logic, a memory and a processor assembled into a substantially ring-shaped housing that is wearable on a finger of a user. The ring-shaped universal input device according to the present disclosure is capable of identifying an external device, establishing a communication channel with an identified external device and providing user instructions to the external device based on user's finger motions or gestures. The motion sensor can detect the finger's various motions and/or gestures and generate corresponding detection signals which are converted by the control logic and processor into instruction signals recognizable by the external device. The instruction signals are communicated to the external device through a wireless communication channel. The universal input device may include multiple ring members and can generate an instruction signal based on a combination of signals detected by multiple sensors.

The universal input device may include a projector that can optically project a graphical user interface to an external surface as a visual guide for user's finger motions or gestures. Therefore, a user can conveniently interact with a variety of electronic devices by wearing the ring-shaped input device and issuing commands through finger motions and gestures.

In accordance with an embodiment of the present disclosure, a control device configured to control a plurality of external devices comprises: (1) an exterior housing of a substantially ring shape and configured to be wearable on a finger of a user; (2) a motion sensor configured to detect a predefined motion of the finger and responsive thereto to generate a motion signal; (3) control logic coupled to the motion sensor and configured to convert the motion signal into digital data; (4) a processor coupled to the control logic; (5) a memory storing executable instructions that, when executed by the processor, cause the processor to perform a method of: identifying an external device that communicates with the control device through a communication channel; processing the digital data; and generating a control instruction based on the external device and the digital data; and (6) a communication circuit coupled to the processor and configured to communicate the control instruction for receipt by the external device through the communication channel, wherein the exterior housing contains the motion sensor, the control logic, the processor, the memory and the communication circuit. The control device may further comprise a phone circuit and a network circuit. The method may further comprise rendering a virtual keyboard GUI that can be projected onto an external wall by a projector contained within the housing.

In another embodiment of present disclosure, a controller configured to control a plurality of external devices comprises: (1) a first ring member comprising: a first exterior housing configured in an annular shape and wearable on a first finger of a user; and a first sensor contained within the first exterior housing and configured to detect a first predefined motion of the first finger and responsive thereto to generate a first motion signal; and (2) a second ring member. The second ring member comprises: (1) a second exterior housing configured in an annular shape and wearable on a second finger of the user; (2) a second sensor configured to detect a second predefined motion of the second finger and responsive thereto to generate a second motion signal; (3) control logic coupled to the second sensor and configured to generate digital data based on a combination of the first motion signal and the second motion signal; (3) a processor coupled to the control logic; (4) a memory embodying executable instructions that, when executed by the processor, cause the processor to perform a method of: identifying an external device that communicates with the controller through a communication channel; processing the digital data; and generating a control instruction based on the external device and the digital data; and (5) a communication circuit coupled to the processor and configured to communicate the control instruction to the external device through the communication channel, wherein the second exterior housing contains the control logic, the processor, the memory and the communication circuit.

In another embodiment of present disclosure, a wireless control system comprise (1) a first housing member and a second housing member, wherein the first and the second housing members are wearable on a first finger and a second finger of a user respectively; (2) a first sensor coupled to the first housing member and configured to detect a first predefined gesture of the first finger and to generate a first detection signal responsive thereto; (3) first control logic coupled to the first sensor and the first housing, wherein the first control logic is configured to convert the first motion signal to first digital data; (4) a second sensor coupled to the second housing member and configured to detect a second predefined gesture of the second finger and generate a second detection signal responsive thereto; (5) second control logic coupled to the second sensor and the second housing, wherein the control logic is configured to convert the second motion signal to second digital data; (6) a processor coupled to the second control logic; (7) a memory storing executable instructions that, when executed by the processor, cause the processor to perform a method of: identifying an external device that communicates with the wireless control system through a wireless communication channel; processing the first digital data and the second digital data; and generating a control instruction based on the external device and on a combination of the first digital data and the second digital data; and (8) a communication circuit coupled to the processor and configured to wirelessly communicate the control instruction to the external device through the communication channel, wherein the second sensor, the processor, the memory and the communication circuit are contained within the second housing.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates a user wearing finger ring input device configured to provide various types of input to a plurality of external devices in response to detecting user finger motions and/or gestures according to an embodiment of the present disclosure.

FIG. 2 illustrates an exemplary exterior design of a finger ring input device in accordance with an embodiment of the present disclosure.

FIG. 3 illustrates an exemplary GUI that is generated by the finger ring input device and projected onto an external wall.

FIG. 4 is a flow chart depicting an exemplary computer implemented method of generating and providing user input to a remote electronic device through a finger ring input device in accordance with an embodiment of the present disclosure.

FIG. 5 is a functional block diagram illustrating an exemplary configuration of a finger ring input device in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Wearable Finger Ring Input Device and Controller

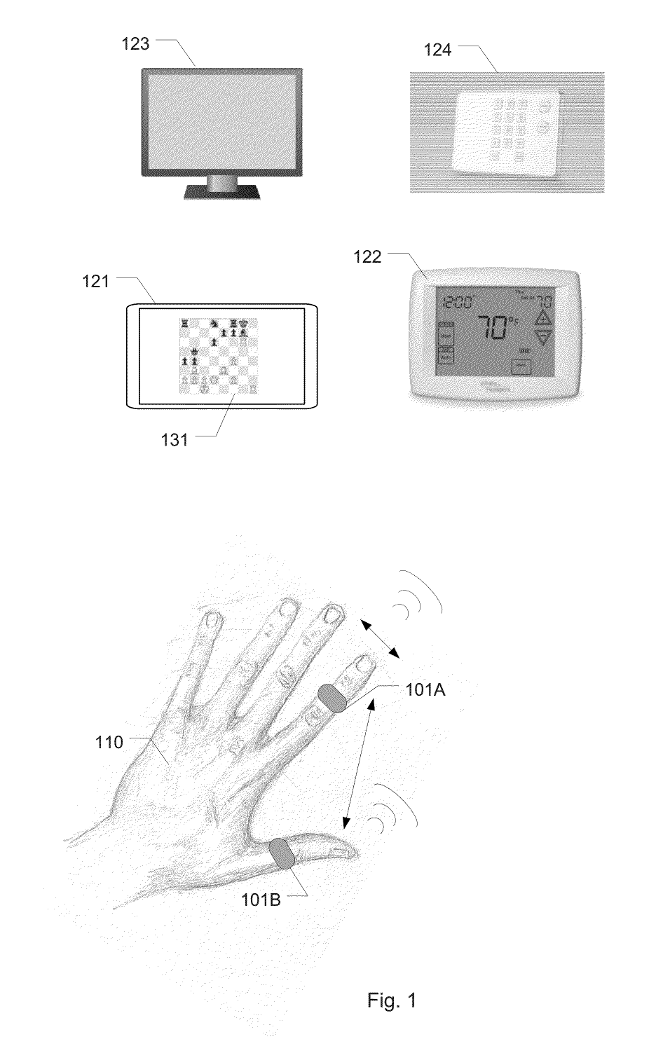

FIG. 1 illustrates a user 110 wearing finger ring input device 101, shown as 101A and 101B, configured to provide various types of input to a plurality of external devices by detecting user finger motions and/or gestures according to an embodiment of the present disclosure. In this embodiment, the input device 101 includes two separate ring members 101A and 101B, each adapted to fit in a respective finger of the user 110. Each ring member includes a motion sensor operable to detect the predefined finger's motions and gestures and to generate detection signals accordingly. At least one of the ring members includes a control logic and processor which can identify an external device selected to receive user input through the finger ring input device, process the detected signals into user instruction signals based on the identification, and transmit to the selected external device through a wireless communication channel for control thereof. Thus, a user can selectively interact with a variety of electronic devices, e.g., 121-124, from a convenient distance and issue commands by moving fingers and making finger gestures through a single input device attached to his or her fingers.

A finger ring input device according to the present disclosure may include a single sensor or multiple sensors, and a single ring member or multiple ring members. It will be appreciated that any suitable motion sensing mechanism that is well known in the art can be used to detect finger motions or gestures. For example, the sensors may include accelerometers, Gyro sensors, G-sensors, digital compass, infrared sensors, or ultrasonic motion detectors, etc.

The sensors can be configured to detect the motions of individual fingers like clicks, shakes, slides, bending, circling, pointing, etc. Motion signals can be generated based on orientation, rotation, speed, and/or relative positions of the fingers, etc. Multiple sensors can collaborate to discern finger motions and/or gestures made by multiple fingers based on the relative positions or position changes of the fingers. A combination of the motion signals detected from multiple fingers may be interpreted as a single user instruction. A series of motions can also be interpreted into a single user instruction based on the trajectory of the fingers. It will be appreciated that each associated external device may recognize a different set of user finger motions or gestures. The same motion or gesture may be interpreted as different user instructions depending on the external device receiving it.

Embodiments of the present disclosure are not limited to any specific type of external devices that can respond to user instructions sent from a wearable finger ring input device in accordance to the present disclosure. The associated external devices may include for example, a mobile computing device 121, a thermostat 122, a television 123, a security control panel 124, a camera, an automatic garage door, an electronic lock, a desktop, an electrical appliance, a game console and so on. The input device may be programmable by a user to associate more or fewer external devices. The input device may be capable of identifying an associated external device upon a user command, or automatically detecting the presence of an associated external device.

Through an instruction interpretation program, the finger ring input device 101 may be configured to provide any appropriate user instruction signals or codes recognizable by an associated external device. For example, when the mobile computing device 121 is in communication with the input device 101, the input device 101 can provide user input like a touchscreen, or a mouse and a keyboard. For instance, the user 110 can select and move the visual objects on the on-screen GUI 131 displayed on the computing device 121 through clicking or dragging actions. The user 110 can also zoom the GUI 131 by finger pinch actions. When a virtual character table is included in a GUI, the user 110 can select a character through a pointing action. The input device 101 may also cause graphic objects to be drawn on a GUI, such as lines or circles that follow the continuous finger motions.

When the input device 101 is used to control the thermostat 122, different finger motions and gestures may result in corresponding control instructions such as dialing up/down a preset temperature, and setting a timer. When the input device 101 is used to control the television 123, it operates to control the television in a similar manner as using a remote controller, such as turning on/off, changing channels, switching signal sources, adjusting volume. When the input device 101 is used to control the security system, it may operate to control the security system in a similar manner as using a control panel 124.

The present disclosure is not limited to any specific communication mechanism or communication protocol that can be used between a wearable finger ring input device and the associated external devices. In some embodiment, the input device is equipped with a radio transceiver which can communicate with the respective transceivers installed on all the associated external devices. The input device may include a network circuit enabling it to communicate with an external device through a communicate network, such as WiFi, local area network (LAN), or a wide area network (WAN). In some embodiments, an input device according to the present disclosure may communicate with the external devices in different mechanisms. For example, the input device 101 may be equipped with an infrared diode as well as a transceiver which are used to transmit user instruction signals to the television 123 and mobile computing device 121 respectively in suitable protocols.

In some embodiments, the multiple ring members in the input device may communicate to each other through flexible wires or through a wireless communication channel. In some embodiments, only one ring member, e.g., a master or primary ring, is equipped with control logic, processor, and a memory, while other ring members is only equipped with sensors, and possibly control logic. Thus, the master ring is responsible to collect and process motions signals from other ring members.

The present disclosure is not limited to any specific geometric or exterior design of the finger ring input device. It will be appreciated that the finger ring device may be designed to have various diameters, widths, length, and shapes, and may be configured to be wearable in any position of a user finger. For instance, a ring member may have a width in the range of 5 mm or 25 mm. In some embodiments, the input device according to the present disclosure may be designed as a closed loop or a partial loop.

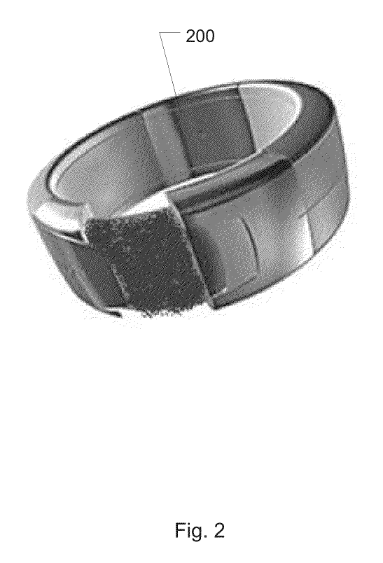

FIG. 2 illustrates an exemplary exterior design of a finger ring input device 200 in accordance with an embodiment of the present disclosure. The exterior housing of the input device may be made of any suitable material or any combination of materials and shaped in a generally annular shape for conforming to the finger.

In some embodiments, a finger ring input device is capable of generating a GUI to provide a visual guide for a user to issue finger motion commands. Such a GUI may be configured specifically to a particular external device. For instance, the GUI may mimic the configuration of a physical control panel of the external device.

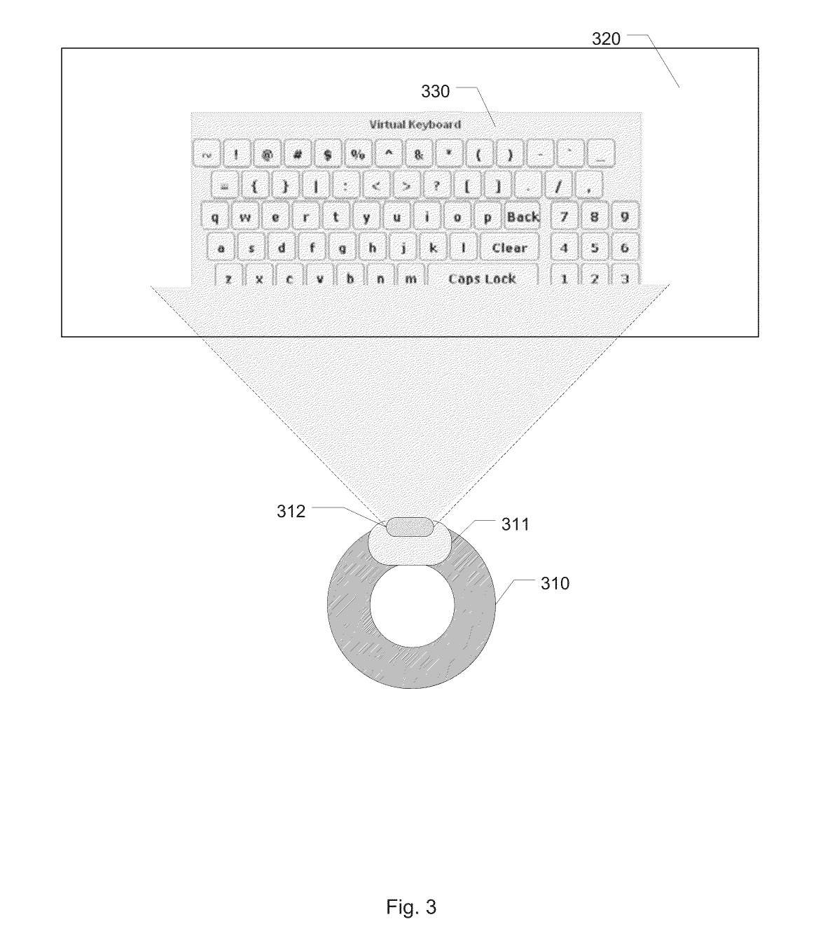

FIG. 3 illustrates an exemplary GUI 330 that is generated by the finger ring input device and projected onto an external wall 320. The input device 310 includes a memory, a processor (not explicitly shown) and a projector 311 enclosed in the housing. A part of the housing is composed of a projector lens 312 associated with the projector 311. The memory stores a virtual keyboard GUI program executable by the processor. The virtual keyboard GUI can be projected by the projector 311 through the projector lens 312 onto any suitable surface, e.g., a wall or a paper. Guided by the virtual keyboard 330, the user can select by pointing the finger to an intended character. Based on the finger motions, or relative positions, the sensor in the input device 310 can then identify the intended character and send an instruction to the external device to enter the intended character.

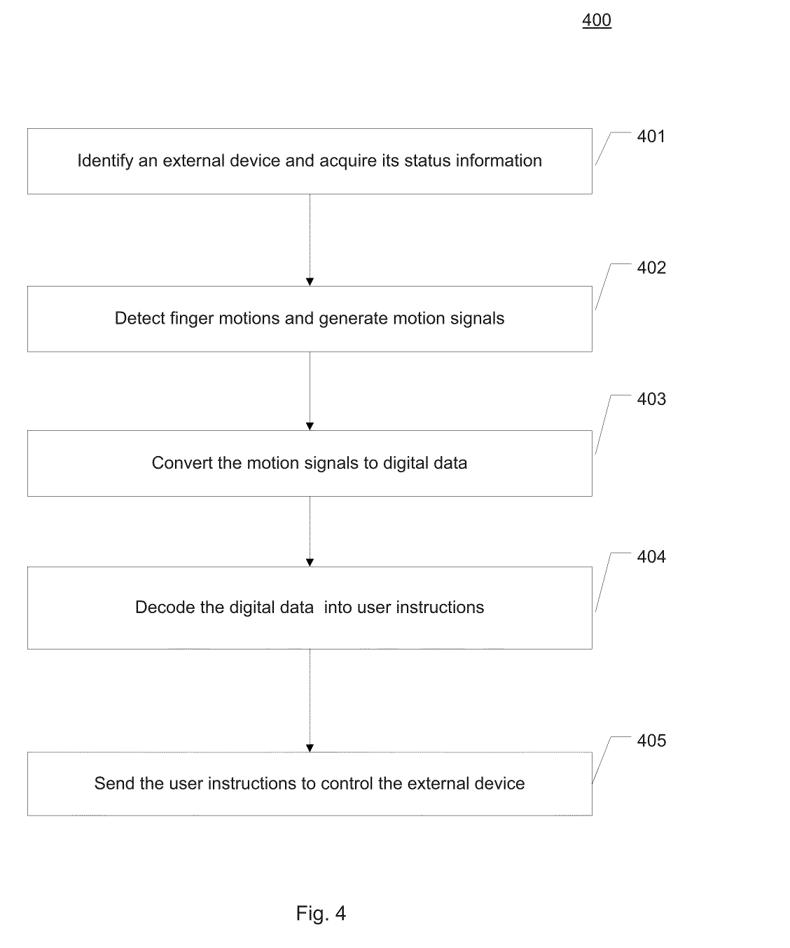

FIG. 4 is a flow chart depicting an exemplary computer implemented method 400 of generating and providing user input to a remote electronic device through a finger ring input device in accordance with an embodiment of the present disclosure. At 401, an associated external device is identified and a corresponding communication channel is established between the finger ring input device and the external device. The status information of the identified device can also be acquired. The external device may be identified by any suitable means. For example, the transceiver of the external device may emit a signal of a predetermined frequency that can be automatically detected by the transceiver in the input device. Alternatively, a user may manually specify an associate external device to exercise control or provide input through the finger ring input device.

At 402, the sensor in the input device can detect predefined finger motions and/or gestures and generate motion signals based on external device in communication. The motion signals may be analog or digital signals. At 402, the control logic coupled with the sensors converts the motion signals to digital data that can then be processed and decoded into user instruction signals by a processor in the input device at 404. The processor can process the digital data in accordance with a finger motion translation program stored in the memory and the translation program can be specific to the external device. At 405, the user instruction signals and/or codes are then sent to the external device through the communication channel. The communication channel can be wireless radio, blue tooth, WiFi, infrared, photooptic, etc.

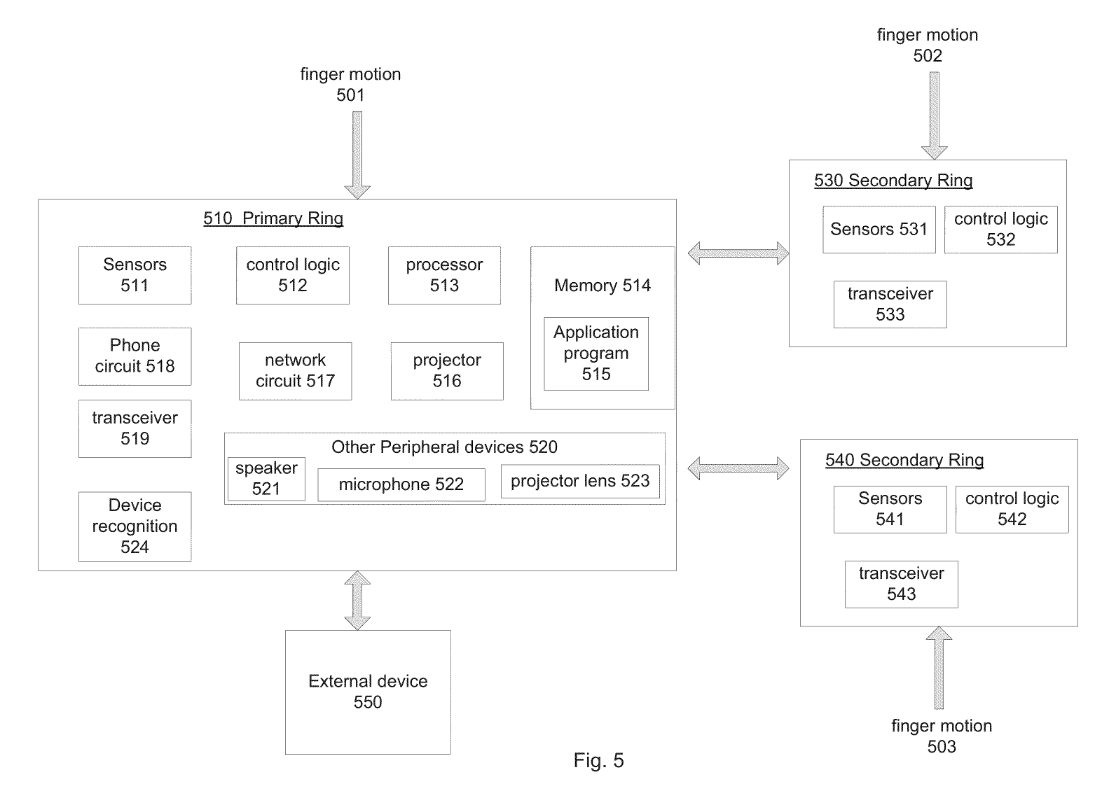

FIG. 5 is a functional block diagram illustrating an exemplary configuration of a finger ring input device 500 in accordance with an embodiment of the present disclosure. The input device 500 comprises a primary ring member 510 and two secondary ring members, 530 and 540. The different ring members may be wearable on different fingers of a user in some embodiments, and on different positions of a single finger in some other embodiments.

Each ring member includes one or more sensors, 511, 531 or 541, to detect finger motions and/or gestures and generate motion signals, and control logic, 512, 532 and 542, operable to covert the respectively detected signals to digital data and optionally processing the digital data preliminarily. The primary ring member 510 additionally includes a processor 513 and a memory 514. The three ring members 510, 530 and 540 can communicate with each other by using the respective transceivers 519, 533 and 543.

The memory 514 stores application programs 515 that are generic to all external devices or specific to individual external devices. The application programs may include programs configured for external device reorganization, status information acquisition, finger motion/gesture interpretation for respective external devices, GUIs for respective external devices, a menu list of all associated devices, establishment of communication networks. The memory may store many other appropriate programs that perform various functions that are well known in the art.

The primary ring member 501 may provide an input/output port allowing a user to configure the application programs, such as for adding or removing an associated external device, adjusting the sensitivity of the sensors, adjusting the margin of tolerance of the finger motion interpretation program, or customizing acceptable finger motions or gestures for an external device. The primary ring 510 also includes a phone circuit 516, a network circuit 517, a projector 518, and other peripheral devices 520, such as a speaker 521, a microphone 522, and a projector lens 523.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A control device configured to control a plurality of external devices, said control device comprising:
an exterior housing of a substantially ring shape and configured to be wearable on a finger of a user;
a motion sensor configured to detect a predefined motion of said finger and responsive thereto to generate a motion signal;
control logic coupled to said motion sensor and configured to convert said motion signal into digital data;
a processor coupled to said control logic;
a memory storing executable instructions that, when executed by said processor, cause said processor to perform a method of:
identifying an external device of said plurality of external devices;
processing said digital data; and
generating a control instruction based on said external device and said digital data; and
a communication circuit coupled to said processor and configured to communicate said control instruction for receipt by said external device through a communication channel,
wherein said exterior housing contains said motion sensor, said control logic, said processor, said memory and said communication circuit.

2. The control device of claim 1 further comprising a phone circuit and a network circuit.

3. The control device of claim 1 further comprising a projector contained within said exterior housing and coupled to said processor, and wherein said exterior housing comprises a projector lens.

4. The control device of claim 3, wherein said method further comprises rendering a virtual keyboard comprising a plurality of characters, wherein said projector is configured to project said virtual keyboard onto an external surface, and wherein said predefined motion signifies a selection of a character from said virtual keyboard.

5. The control device of claim 1, wherein said plurality of external devices comprises one of a television, a camera, a DVD player, a security control panel, a thermostat, a mobile computing device, and a game console.

6. The control device of claim 1, wherein said method further comprises: automatically detecting presence of said external device; establishing said communication channel in response to said detecting; adjusting a margin of tolerance in response to a user request with reference to sensitivity of said motion sensor.

7. The control device of claim 1, wherein said predefined motion is selected from a group consisting of a shake motion, a click motion, a slide motion, a circling motion, and a bending motion.

8. The control device of claim 1, wherein said external device comprises a display panel, wherein said external device is configured to present a graphic user interface (GUI) comprising user interaction with on-screen objects on said display panel, and wherein said external device is configured to adapt said GUI in response to said control instruction.

9. The control device of claim 1, wherein said communication circuit comprises a transceiver.

10. A controller configured to control a plurality of external devices, said controller comprising:
a first ring member comprising:
a first exterior housing configured in an annular shape and wearable on a first finger of a user; and
a first sensor contained within said first exterior housing and configured to detect a first predefined motion of said first finger and responsive thereto to generate a first motion signal; and
a second ring member comprising:
a second exterior housing configured in an annular shape and wearable on a second finger of said user; and
a second sensor configured to detect a second predefined motion of said second finger and responsive thereto to generate a second motion signal;
control logic coupled to said second sensor and configured to generate digital data based on a combination of said first motion signal and said second motion signal;
a processor coupled to said control logic;
a memory embodying executable instructions that, when executed by said processor, cause said processor to perform a method of:
identifying an external device that communicates with said controller through a communication channel;
processing said digital data; and
generating a control instruction based on said external device and said digital data; and
a communication circuit coupled to said processor and configured to communicate said control instruction to said external device through said communication channel,
wherein said second exterior housing contains said control logic, said processor, said memory and said communication circuit.

11. The controller of claim 10, wherein said first ring member and said second ring member comprise respective transceivers, and wherein said first motion signal is transmitted from said first ring member to said second ring member through said respective transceivers.

12. The controller of claim 10, wherein said second ring member further comprises a wireless phone circuit.

13. The controller of claim 10, wherein said external device comprises a display panel configured to display a graphic user interface (GUI) to said user, wherein said external device is configured to adapt said GUI in response to said control instruction.

14. The controller of claim 10 further comprises a projector contained within said second exterior housing and coupled to said processor, and wherein said second exterior housing comprises a projector lens.

15. The control device of claim 14, wherein said method further comprises generating a GUI associated with said external device, wherein said GUI comprises a user interaction object, wherein said projector is configured to project said GUI to a surface external to said universal control device, and wherein said predefined motion signifies a user interaction with said user interaction object.

16. A wireless control system comprising:
a first housing member and a second housing member, wherein said first and said second housing members are wearable on a first finger and a second finger of a user respectively;
a first sensor coupled to said first housing member and configured to detect a first predefined gesture of said first finger and to generate a first detection signal responsive thereto;
first control logic coupled to said first sensor and said first housing, wherein said first control logic is configured to convert said first motion signal to first digital data;
a second sensor coupled to said second housing member and configured to detect a second predefined gesture of said second finger and generate a second detection signal responsive thereto;
second control logic coupled to said second sensor and said second housing, wherein said control logic is configured to convert said second motion signal to second digital data;
a processor coupled to said second control logic;
a memory storing executable instructions that, when executed by said processor, cause said processor to perform a method of:
identifying an external device that communicates with said wireless control system through a wireless communication channel;
processing said first digital data and said second digital data; and
generating a control instruction based on said external device and on a combination of said first digital data and said second digital data; and
a communication circuit coupled to said processor and configured to wirelessly communicate said control instruction to said external device through said communication channel,
wherein said second sensor, said processor, said memory and said communication circuit are contained within said second housing.

17. The wireless control system of claim 16, wherein said communication circuit comprises a transceiver configured to communicate with a transceiver installed on said external device.

18. The wireless control system of claim 16, wherein said external device is selected from a group consisting of a television, a camera, a DVD player, a security control panel, a thermostat, a mobile computing device, and a game console, and wherein said method further comprises detecting presence of said external device.

19. The wireless control system of claim 16 further comprising an image projector contained by said second housing, wherein said method further comprises rendering said image projector to project a graphic user interface (GUI), wherein said GUI comprises a user interaction object, and wherein said second predefined gesture corresponds to a user interaction with said user interaction object.

20. The wireless control system of claim 16, wherein said control instruction is selected from a group consisting of activating, deactivating, changing volume, changing a channel, tuning up/down temperature, entering a character, and selecting a visual object displayed on said external device.
